(19) United States
(12) Patent Application Publication
(10) Pub. No.: US 2014/0338768 A1
(43) Pub. Date: Nov. 20, 2014

(54) Device For Inducing A Vortical Fluid Flow

(71) Applicant: Mario Marcic, Calgary (CA)

(72) Inventor: Mario Marcic, Calgary (CA)

(21) Appl. No.: 13/895,047

(22) Filed: May 15, 2013

(51) Int. Cl. F15D 1/00

(52) U.S. Cl. CPC F15D 1/009
USPC 137/808

(57) ABSTRACT

A device for inducing a vortical fluid flow includes a central hub and a plurality of vanes that extend radially from the central hub. Each vane has an interior edge that extends substantially along the length of the hub, a top edge that tapers from narrow to wide in the direction from an inlet end towards an outlet end of the device, a vertical outer edge, and an outside corner at the outlet end bent inwardly at a 45-degree angle to a longitudinal axis of the central hub.

### FIELD OF THE INVENTION

The present invention relates generally to the flow of fluid in a conduit, and more particularly, relating to a device for inducing a vortical fluid flow in a conduit.

### BACKGROUND OF THE INVENTION

It is known that a spinning flow of combustion exhaust gas through a flue pipe is more efficient than a non-spinning flow of combustion exhaust gas through the same flue pipe. A spinning flow of combustion exhaust gas encourages the combustion gas to exit the flue pipe as opposed to back flowing towards the combustion source. Also a spinning flow of combustion exhaust gas also prevents debris from sticking to the interior of the flue pipe and clogging the flue pipe.

It is also known that a spinning flow of pre-combustion gas into the combustion chamber of an internal combustion engine increases combustion efficiency and reduces pollution contained within the combustion exhaust gas.

There exist numerous devices of various constructions aimed at the purpose causing combustion exhaust gas to spin as it flows through a flue pipe. There also exist numerous devices of various constructions similarly aimed at the purpose of causing pre-combustion gas in an internal combustion engine to spin as it flows into a combustion chamber. While the devices heretofore fulfill their respective, particular objectives and requirements, a need exists for an improved device, which substantially departs from the prior art, and in doing so provides an apparatus primarily developed for the purpose of inducing a vortical fluid flow in a conduit.

### SUMMARY OF THE INVENTION

In view of the foregoing disadvantages inherent in the known types of fluid flow arrangements now present in the prior art, the present invention provides a new a device for inducing a vortical fluid flow wherein the same can be used for increasing the efficiency of a furnace or a combustion engine.

In general, in one aspect, a device for inducing vortical flow in a fluid moving through a conduit is provided. The device includes a central hub and a plurality of vanes that extend radially from the central hub. Each vane has an interior edge that extends substantially along the length of the hub, a top edge that tapers from narrow to wide in the direction from an inlet end towards an outlet end of the device, a vertical outer edge, and an outside corner at the outlet end bent inwardly at a 45-degree angle to the longitudinal axis.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a perspective view of a device for inducing vortical fluid flow constructed in accordance with the principles of and embodiment of the present invention;

FIG. 2 is a schematic view of the device of FIG. 1 fitted within a flue pipe; and

FIG. 3 is a cross-sectional view of the device of FIG. 1 within the flue pipe.

### DETAILED DESCRIPTION OF THE INVENTION

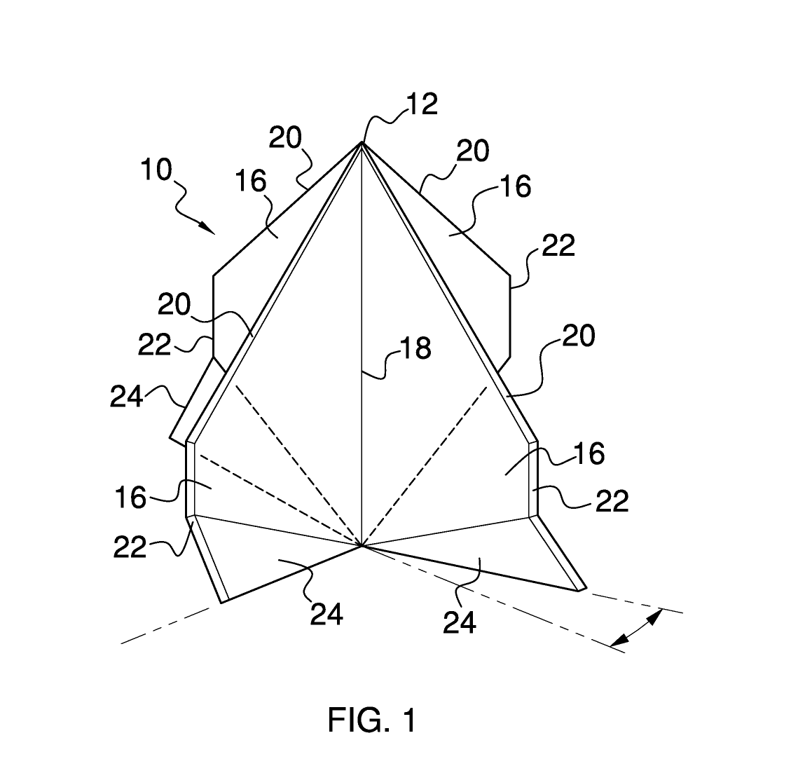

With reference to FIGS. 1 through 3, there is representatively illustrated a new device 10 inducing vortical flow in a fluid moving through a conduit in accordance with an embodiment of the present invention.

Device 10 includes a central hub 12 with a longitudinal axis 14 and a plurality of vanes 16 extending radially from the central hub. Each vane 16 has an interior edge 18, a top edge 20, a vertical outer edge 22, and an outside corner 24. The interior edge 18 of each vane 16 extends substantially long the length of said central hub 12 between an inlet end 26 and an outlet end 28 of device 10. The top edge 20 of each vane 16 tapers from narrow to wide in a direction from the inlet end 26 towards the outlet end 28. Collectively, top edges 20 define the inlet end 26 of device 10 as a cone. The outside corner 24 is inwardly bent toward the central hub 12 at a 45-degree angle with respect to the longitudinal axis 14.

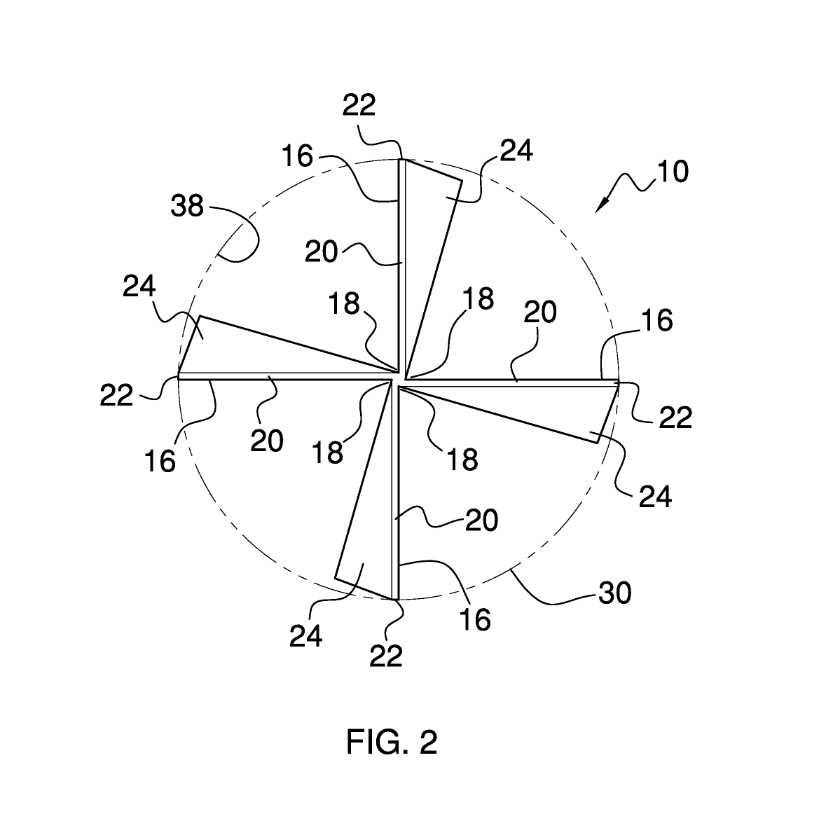

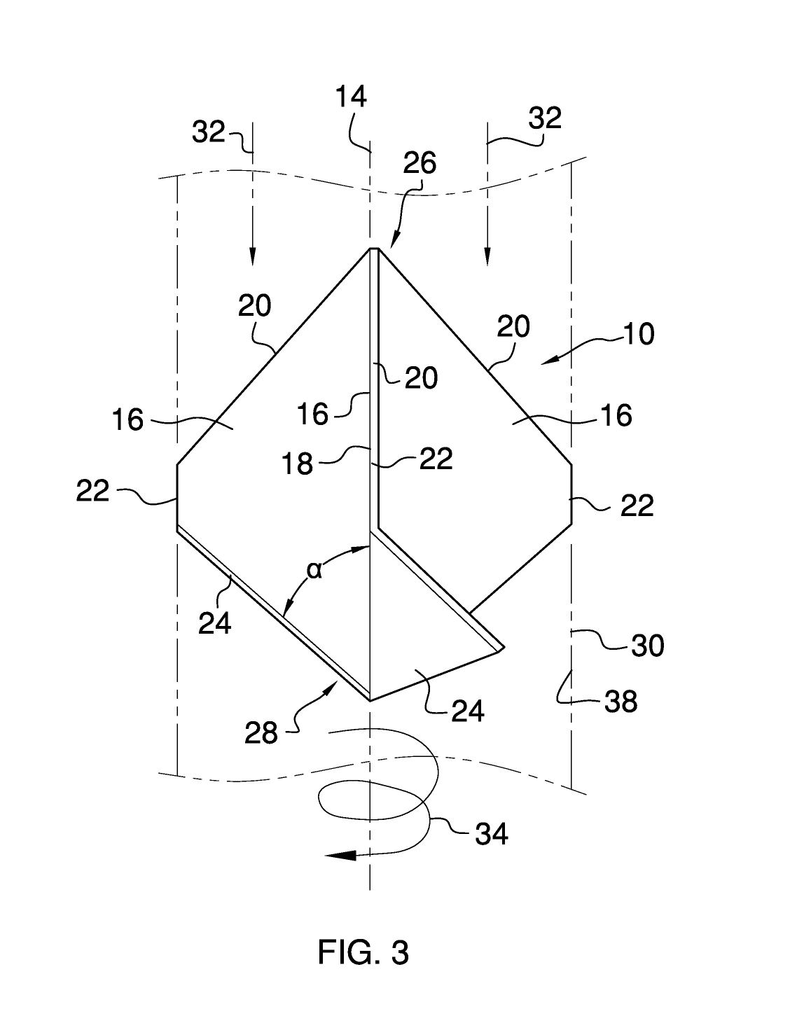

With reference to FIGS. 2 and 3, device 10 is shown positioned within a conduit, such as, a flue pipe 30 of a furnace or the like. Device 10 is fixedly positioned within the flue pipe 30 with the longitudinal axis 14 co-axially aligned with a longitudinal axis of the flue pipe and so that it does not rotate about its axis. More specifically, device 10 is positioned within flue pipe 30 with its inlet end 26 disposed upstream of its outlet end 28 relative to a flow combustion gas 32 through the flue pipe and with only the vertical outer edge 22 of each vane 16 contacting the interior wall 38 of the flue pipe.

As best illustrated in FIG. 3, the length of the vertical outer edge 22 is much less than the length of the tapered top edge 20, and in some embodiments, the length of the vertical outer edge is as much as 5-times less than the length of the tapered top edge. The purpose of this is to reduce the linear contact area between device 10 and the interior wall 38 of the flue pipe 30 to reduce drag forces on the flow of combustion gas 30 through the flue pipe. Reducing drag forces created by a large contact surface between the vanes 16 and the interior wall 38 allows the device 10 to induce a more smooth vortical flow in the combustion gas. This is further enhanced by the tapered top edges 20 that provide a smooth transition of the flow of combustion gas 32 across vanes 16. As the combustion gas 32 continues to flow across vanes 16 and inwardly bent corners 24, the combustion gas is caused to spin as a vortical flow 34 within the flue pipe 30 downstream of device 10.

Although device 10 has been described in connection with a flue pipe of a furnace, it is not limited in application. Device 10 may be employed in a number of applications where inducing a vortical flow in a fluid moving through an enclosed conduit is desirable. As one example, device 10 may readily be used in connection with a combustion engine wherein the device 10 may be positioned within the intake of the combustion engine to increase fuel economy.

A number of embodiments of the present invention have been described. Nevertheless, it will be understood that various modifications may be made without departing from the spirit and scope of the invention. Accordingly, other embodiments are within the scope of the following claims.

What is claimed is:

1. A device for inducing vortical flow in a fluid moving through a conduit, the device comprising:
a central hub having a length and a longitudinal axis; and
a plurality of vanes radially extending from said central hub, each vane having an interior edge that extends substantially along said length of said hub, a top edge that tapers from narrow to wide in the direction from an inlet end towards an outlet end of said device, a vertical outer edge, and an outside corner at said outlet end bent inwardly at a 45-degree angle to said longitudinal axis.

2. The device of claim 1, wherein the length of said vertical edge is at least 3-times less than the length of said top edge.

3. The device of claim 1, wherein each vane is fixedly attached to said central hub.

4. The device of claim 1, wherein said plurality of vanes includes four-vanes.

5. The device of claim 1, wherein said plurality of vanes intersect at their interior edges, said intersection providing said central hub.

6. A device for inducing vortical flow in a fluid moving through a conduit, the device comprising:
a central hub having a length and a longitudinal axis;
a plurality of vanes radially extending from said central hub, each vane having an interior edge that extends substantially along said length of said hub, a top edge that tapers from narrow to wide in the direction from an inlet end towards an outlet end of said device, a vertical outer edge, and an outside corner at said outlet end bent inwardly at a 45-degree angle to said longitudinal axis; and
said device fixed in a conduit with said inlet end positioned upstream of said outlet end in relation to a flow of fluid through said conduit, and with each of said vertical outer edges in contact with an interior wall of said conduit.

7. The device of claim 6, wherein the length of said vertical edge is less than the length of said top edge.

8. The device of claim 7, wherein only said vertical outer edges contact said interior wall of said conduit.

9. The device of claim 6, wherein the length of said vertical edge is at least 3-times less than the length of said top edge.

10. The device of claim 9, wherein only said vertical outer edges contact said interior wall of said conduit.

11. The device of claim 6, wherein each vane is fixedly attached to said central hub.

12. The device of claim 6, wherein said plurality of vanes includes four-vanes.

13. The device of claim 6, wherein said plurality of vanes intersect at their interior edges, said intersection providing said central hub.
